(19) United States
(12) Patent Application Publication
(10) Pub. No.: US 2010/0059485 A1
(43) Pub. Date: Mar. 11, 2010

(54) MIG-MIG Welding Process

(75) Inventors: Richard M. Hutchison, New London, WI (US); Joseph K. Fink, Black Creek, WI (US)

Correspondence Address: CORRIGAN LAW OFFICE, 5 BRIARCLIFF CT, APPLETON, WI, 54915, US

(73) Assignee: ILLINOIS TOOL WORK INC., Glenview, IL (US)

(21) Appl. No.: 11/793,321

(22) PCT Filed: Dec. 19, 2005
(86) PCT No.: PCT/IB2005/054323

§ 371 Date: Nov. 30, 2009

Related U.S. Application Data
(60) Provisional application No. 60/644,199, filed on Jan. 13, 2005.

(51) Int. Cl. B23K 9/173

(52) U.S. Cl. 219/74; 219/136

(57) ABSTRACT

A method and apparatus for MIG-MIG welding includes at least first and second sources (104,114) of wire, and first and second sources of power (102,112). The first source of wire provides a first wire (106) to a main arc between the first wire (106) and a workpiece (110). The first source of power (102) provides MIG power to a first current path including the first wire (106) and the workpiece (110). The second source of wire provides a second wire to a filler arc between the first wire (106) and the second wire (116). The second source of power (112) provides MIG power to a second current path including the first wire (106) and the second wire (116).

### FIELD OF THE INVENTION

The present invention relates generally to the art of welding. More specifically, it relates to a welding process with two or more MIG wires.

### BACKGROUND OF THE INVENTION

There are a wide number of known welding processes used for a variety of welding applications. Various processes have strengths and weaknesses with respect to characteristics such as speed, precision, workpiece composition, cost, flexibility, etc.

For example, MIG welding (metal inert gas welding) is relatively fast, but somewhat imprecise. The process is fast because, in part, a consumable wire electrode is used as a filler metal. However, for some applications, an even faster MIG process is desired. MIG welding can be performed as a DC process or an AC process, but typical prior art MIG (also called GMAW) systems use a dc electrode positive (EP) output. There are a number of known MIG processes, including spray and pulse. A MIG spray process involves the filler wire metal being transferred to the workpiece by magnetic forces as small droplets (the spray). Pulsed MIG includes alternating between a higher current DC pulse (during which spray transfer occurs) and a lower current dc background during which the arc is maintained). Pulse mode is desirable for some applications, and spray mode for other applications.

DC MIG welding systems can be relatively low cost, because they can have simple power circuits. The arc is between a continuously fed filler metal (consumable) electrode and the workpiece. Externally supplied gas or gas mixtures provide shielding. MIG welding often is performed by welding along a weld path that is a groove along the workpieces to be joined.

AC MIG has been used for high deposition MIG welding (see U.S. Pat. No. 6,723,957). However, the AC MIG process can be difficult to maintain through a zero crossing—the current must pass through zero at each polarity change, and this can cause the MIG arc to extinguish.

Some prior art welding systems combine different processes. Such combined systems provide two wires and two power sources, and the wires are operated adjacent one another. For example, plasma-MIG welding is known, as is MIG-TIG welding. An example of plasma MIG can be found in Double Electrodes Improve GMAW Heat Input Control, welding Journal, November 2004, Page 39. This article also states that the plasma gun may be replaced by a MIG gun (page 41). An example of MIG-TIG welding can be found in U.S. Pat. No. 6,693,252, hereby incorporated by reference.

While these systems might offer advantages in greater speed or precision over a conventional MIG system, they also have the disadvantages of both systems being combined.

Accordingly, a MIG welding system that is high speed and dc is desirable. Preferably, such a system can operate in a pulse or spray mode.

### SUMMARY OF THE PRESENT INVENTION

Various aspects of the invention include a MIG-MIG welding system having at least first and second sources of wire, and first and second sources of power. The first source of wire provides a first wire to a main arc between the first wire and a workpiece. The first source of power provides MIG power to a first current path including the first wire and the workpiece. The second source of wire provides a second wire to a filler arc between the first wire and the second wire. The second source of power provides MIG power to a second current path including the first wire and the second wire.

According to other aspects of the invention a method of MIG-MIG welding includes feeding a first wire to a main arc between the first wire and a workpiece, and providing MIG power through a first current path including the first wire and the workpiece. A second wire is fed to a filler arc between the first wire and the second wire, and MIG power is provided through a second current path including the first wire and the second wire.

One aspect provides that the first wire is EP and the second wire is EN.

Another aspect includes a user adjustable voltage control that effects a change in the intersection of the first wire and the second wire. The user adjustable voltage control can be an arc voltage control.

Another aspect includes the main arc and the filler arc spatially overlapping.

Another aspect includes a first MIG gun, through which the first wire is provided in a first direction, and a second MIG gun through which the second wire is provided in a second direction. The second direction is at an angle A relative to the first direction. The guns are mounted on a gun assembly that includes an adjustment mechanism for adjusting angle A. The adjustment mechanism can be responsive to a user adjustable control and/or feedback from the arc.

Various aspects provide that the wires may be different, and the first wire is a solid wire or metal core or tubular wire, and/or the second wire is solid wire or metal core or tubular wire.

Other aspects provide that the wires have different sizes or are different alloys.

Various aspects provide the first and second sources of power provide CV and/or CC power, and/or pulse or spray power.

Another aspect includes a controller. The controller includes a first wire feed speed control connected to the first source of wire, and a second wire speed output control connected to the second source of wire. The controller controls the relative speeds and has a user adjustable balance control that effects a change in a ratio of the wire feed speeds, without changing the sum of the wire feed speeds. The balance control may be a penetration control. In another aspect the controller can also change the sum without changing the ratio, in response to a user adjustable wire feed speed control.

Another aspect includes controlling the current magnitude from the first source of EP MIG power, and the current magnitude from the second source of EN MIG power. A user adjustable balance control changes the ratio of the magnitudes without changing the sum of the magnitudes. The balance control may be a penetration control. Another aspect changes the sum while not changing the ratio.

Another aspect includes a method of filling a gap using MIG-MIG welding by feeding a first wire to a main arc between the first wire and a workpiece and providing MIG power through a first current path including the first wire and the workpiece. Also, a second wire is fed to a filler arc between the first wire and the second wire, and MIG power is provided through a second current path including the first wire and the second wire. This results in melting the first wire and the second wire to fill the gap.

Another aspect includes a hard facing by feeding a first wire to a main arc between the first wire and a workpiece and providing MIG power through a first current path including the first wire and the workpiece. Also, a second wire is fed to a filler arc between the first wire and the second wire, and MIG power is provided through a second current path including the first wire and the second wire. At least one of the wires includes carborundum.

Another aspect includes a MIG-MIG-MIG welding system that has three sources of wires and three sources of power. Current flowing through two wires also flows through the third wire.

Other principal features and advantages of the invention will become apparent to those skilled in the art upon review of the following drawings, the detailed description and the appended claims.

### BRIEF DESCRIPTION OF THE DRAWINGS

FIG. 1 is a schematic of a MIG-MIG welding system in accordance with the preferred embodiment FIG. 2 is graph showing power reduction for various EN deposition percentages;

FIGS. 3A and 3B show a gun assembly with the guns in different positions in accordance with the preferred embodiment; and

FIG. 4 shows an alternative gun/wire arrangement.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular welding system using particular components and used for particular applications, it should be understood at the outset that the invention could be implemented using others systems and components, and used for other applications.

The invention generally relates to MIG-MIG welding. The preferred embodiment provides for an arc between a first MIG wire (referred to herein as the main wire) and the workpiece, and an arc between a second MIG wire (referred to herein as the fill wire) and the first wire. The arc between the main wire and the workpiece is referred to herein as a main arc, and the arc between the wires is referred to herein as a filler arc.

Preferably, the main wire is EP and the fill wire is EN. MIG-MIG welding, as used herein, is welding simultaneously performed with two wires where each wire is provided MIG power, and the current paths overlap through at least one wire. MIG power, as used herein, is power suitable for a MIG process.

The arcs may be spatially distinct, overlapping or coextensive, but are referred to herein as distinct arcs because they are part of distinct current paths. Specifically, the main arc is in a current path that includes the main wire, the main arc, the workpiece and a main power supply. The filler arc is in a current path including the main wire, the filler arc, the filler wire, and a filler power supply.

The main current heats the plate and contributes to melting the main wire. The filler current melts the filler wire and contributes to melting the main wire. Thus, by increasing the filler current, a greater percentage of input power melts the wires, and a lessor percentage heats the plate. This can be used to control relative deposition and penetration as desired for particular processes. The control can be in response to user settings and/or arc feedback and/or output feedback. Arc feedback, as used herein, refers to feedback from the main or the fill arc.

The preferred embodiment further provides for the respective guns to be mounted on an assembly wherein the angle between the wires is adjustable. The adjustment may be automatic and/or in response to a user setting, and this controls the intersection of the wires. The control can also be in response to arc feedback and/or output feedback. Intersection of the wires, as used herein, is the location where the wires meet given the direction they are fed (if they would not be consumed by the arc). This can be used for controlling arc voltage, burn-off rate, or other arc parameters.

The wires need not be the same, and can be solid or tubular, such as metal core, and of different alloys or sizes. If different wires are used, the alloy percentages of the weld can be controlled by changing the relative wire feed speeds. For example, steel and aluminum wires could produce any mixture of steel and aluminum in the weld. The mixture can be automatically adjusted with a balance control. The control can be in response to user settings and/or arc feedback and/or output feedback.

The power can be CC or CV, pulsed or spray, i.e., power suitable for CC, CV, pulsed MIG welding, or spray MIG welding, and need not be the same. The relative and total wire feed speed and/or current magnitudes can be adjusted to control deposition rate, penetration, and other welding characteristics. The front panel preferably includes a panel having a user adjustable penetration or balance control, and a user adjustable deposition or current (or total current) control. The control can also be in response to arc feedback and/or output feedback.

The invention is implemented in the preferred embodiments to be used in spray MIG, pulse MIG, gap filling and hard facing.

The preferred embodiment can be used to enhance welding in a variety of aspects, as will be evident from the discussion below, including increasing deposition, decreasing the likelihood of undercut and other fill issues, lowering heat input to the workpiece, control/vary penetration at constant deposition, alloying different wire compositions in the puddle to match the base material, and improving gap filling capabilities. Various embodiments provide one, or more of these improvements.

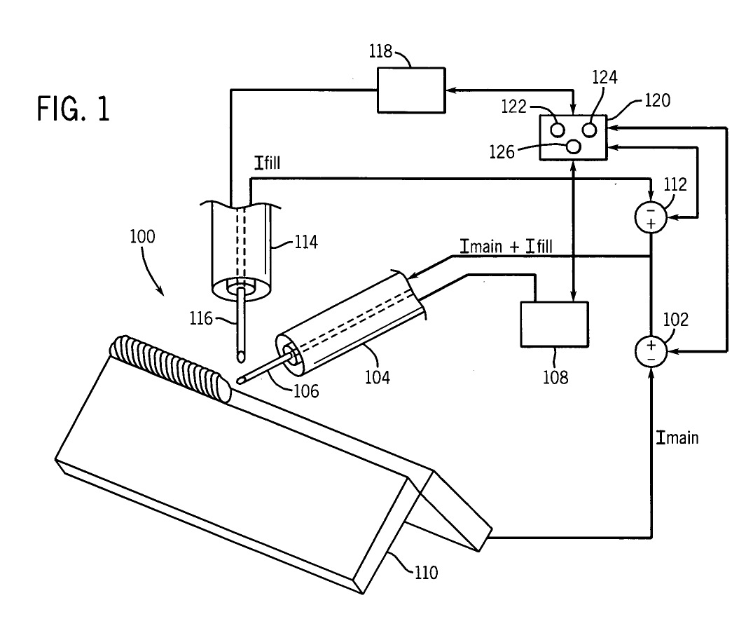

Referring now to FIG. 1, a MIG-MIG welding system 100, in accordance with the preferred embodiment, includes a main power supply 102, and a main MIG gun 104 that feeds a main wire 106 from a wire source 108 to a main arc between wire 106 and a workpiece 110. Also, system 100 includes a filler power supply 112 and a filler MIG gun 114 that feeds a filler wire 116 from a wire source 118 to a filler arc between wire 106 and wire 116. It may be seen that main power supply 102 is EP, and filler power supply 112 is EN. Power supply 102 provides main current Imain, and power supply 112 provides filler current Ifill. Thus, the current through wire 106 is Imain plus Ifill. Alternative embodiments provide for other polarity welding, including power supply 102 being EN, and power supply 112 being EP. Also, various embodiments provide that power supplies 102 and 112 be AC, and/or provide pulse MIG power, and/or provide spray MIG power. The power provided by one power supply need not be the same as the power provided by the other power supply.

Power sources or supplies 102 and 112 have topologies and controls similar to a Miller Axcess 450® power supply in the preferred embodiment. They may be housed in separate housings, or in a single housing. Power supply or source, or source of power, as used herein, includes the power circuitry such as rectifiers, switches, transformers, SCRs, etc. that process and provide the output power.

One preferred embodiment provides a common controller 120 that controls power supply 102, power supply 112, wire feeder 108 and wire feeder 118. Preferably, controller 120 includes user settings 122, 124 and 126. User adjustable setting 122 is used to control the combined wire feed speed, or combined current output of both power supplies (this could be called a current, total current, WFS, or deposition rate control.) User adjustable control 124 is used to control the ratio of wire feed speed or current output, or relative balance between the two power supplies (this could be called, for example, balance or penetration, control, since increasing the EP output increases penetration). User adjustable control 126 controls the angle of the wires relative to one another, or the location the wires intersect. This may also be called voltage or arc length control. Conventional MIG settings or other setting may be included, such as pulse, spray, CV/CC, dc/ac, etc. These controls can also be in response to arc feedback and/or output feedback.

The power supplies and controller may be in separate housings, or in one housing. The controller can be a complete common controller, two distinct separate controllers, or a combination of distinct and common controllers. Also, other topologies may be readily used. The wire sources can be prior art MIG wire feeders, and the controllers can be housed with the wire feeder, with the power source, elsewhere, or distributed in various locations.

The preferred embodiment of a MIG-MIG system with the main arc EP and the filler arc EN reduces the total power needed to deposit a given amount of wire. For example, the inventors determined that for a 0.45″ metal core wire, to obtain a combined wire feed speed of 1000 IPM required less total power when the balance was changed to increase EN. The power needed for 55% EN deposition and 45% EP deposition was 57.7% less than the power needed for 100% EP deposition. Thus, using ratios around 55:45 gave particularly good results for a low dilution/penetration weld, although other ratios are also desirable for other welds. The table below and FIG. 2 show experimental data for different percent EN depositions. Imain is the main current, Ifill is the fill current, Vmain is the main output voltage, Vfill is the fill output voltage, WFS is the wire feed speed (IPM) for the EN and EP wires, Ben and Bep are the burn rates (kg/amp-sec) for the EN and EP wires, total power is the sum of the main power and the fill power (obtained by multiplying Imain by Vmain, and Ifill by Vfill), and power reduction is obtained by making a comparison to the power at 100% EP.

| Imain | Ifill | Vmain | Vfill | WFSep | WFSen | Bep | Ben | Total Power | % Reduct. |
|---|---|---|---|---|---|---|---|---|---|
| 470 | 0 | 36.4 | 0 | 100 | 0 | 2.13 | | 17108 | |
| 290 | 158 | 31.8 | 28 | 700 | 300 | 1.56 | 1.90 | 13646 | 20.2 |
| 109 | 250 | 29 | 28.9 | 500 | 500 | 1.39 | 2.00 | 10386 | 39.3 |
| 42 | 263 | 22 | 25 | 450 | 550 | 1.48 | 2.09 | 7236 | 57.7 |

Too much EN could result in globular transfer, and too little EN could result too little deposition increase or too little power reduction. The reduced power means less heat into the plate, therefore reducing the power can affect the quality of the weld. One control is to control penetration with a constant deposition rate (by adjusting balance but keeping total WFS constant). The control can be in response to user settings and/or arc feedback and/or output feedback. Alternatives provide for the balance control to adjust the ratio of main to fill output current, rather than the ratio of main to fill wire feeds speeds. Optimal adjustment for EP/EN ratio may be made automatically for higher deposition, reduced power, or weld quality, or the user may make the adjustment.

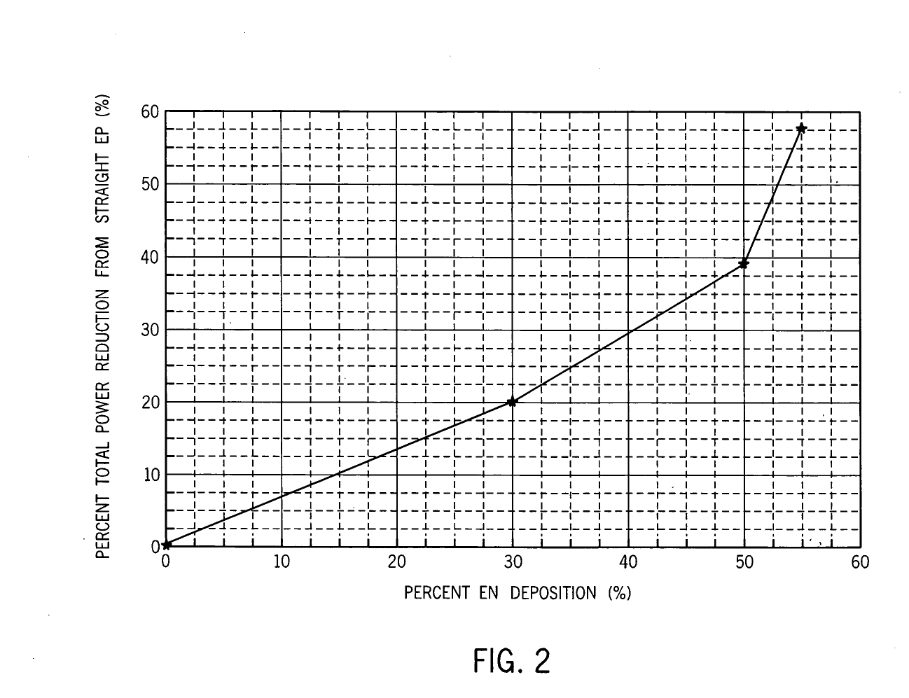

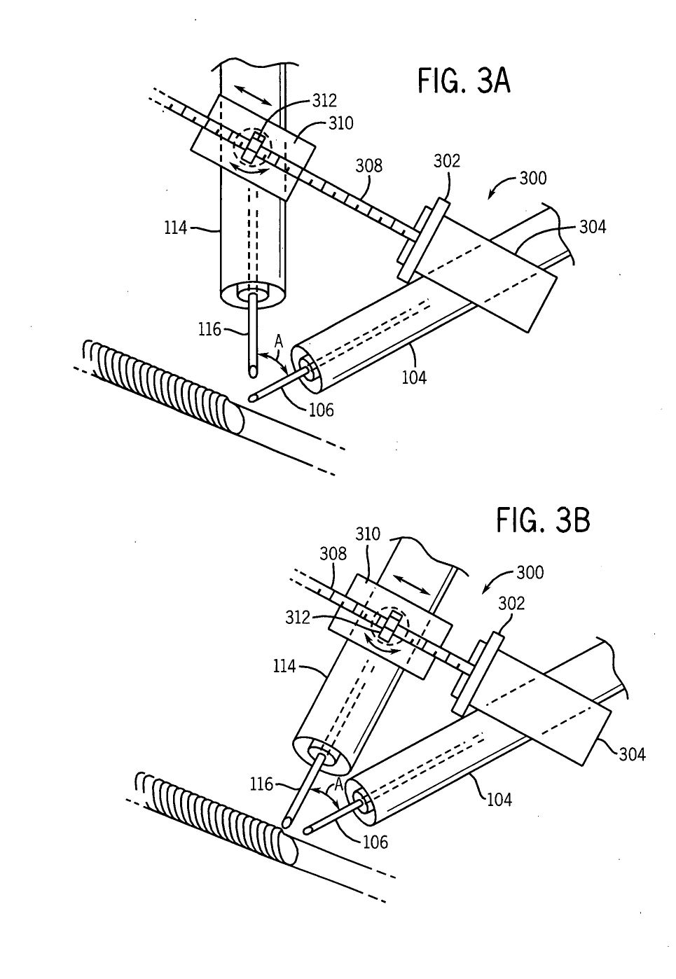

Referring now to FIGS. 3A and 3B, a gun assembly 300 allows for adjusting the angle between wires 106 and 116, and thus the point at which wires 106 and 116 intersect. This can be used for controlling arc voltage, burn off rate, or other arc parameters. Gun assembly 300 includes brackets 304 and 310. Bracket 304 is mounted to gun 104, and a motor 302 is mounted on bracket 304. Motor 302 is connected to a rotatable threaded rod 308. Bracket 310 is mounted to gun 114, and includes a fixed nut 312, which receives threaded rod 308. Motor 302 turns threaded rod to move relative to nut 312, and thus move bracket 310 and gun 114 relative to gun 104, as shown by the arrows. FIGS. 3A and 3B show gun 114 in different positions, having a different angle A between the guns.

Guns 104 and 114 are preferably standard MIG guns, but other guns, water cooled for example, may be used. Alternative gun assemblies and mechanisms for adjusting the guns positions may be used, including manual adjustment, no adjustments, and deflecting the diffuser on one of the guns.

Motor 302 preferably is controlled by controller 120 (FIG. 1) to adjust the angle, and thus the intersection point to obtain a desired arc voltage. If the wires are more parallel, as shown in FIG. 3B, there will be a greater burn off rate, and a lessor arc voltage. The control can be in response to user adjustable (arc or output) voltage control or arc length control 126, or done automatically.

The second arc can reduce the plasma cone (relative to standard MIG), which may be desirable for welding deeper grooves. Moreover, the angle control can also be used to effect changes in the plasma arc, and may be used for adjusting to deeper or shallower grooves.

The preferred embodiment shows the main arc leading the filler arc. Other arrangements, including the filler arc leading, or the arcs being side by side, are used in various embodiments.

The preferred embodiment provides using system 100 in a variety of processes, including high deposition processes, gap filling, and hard facing. Hard facing, for example, may be performed by using a wire including carborundum.

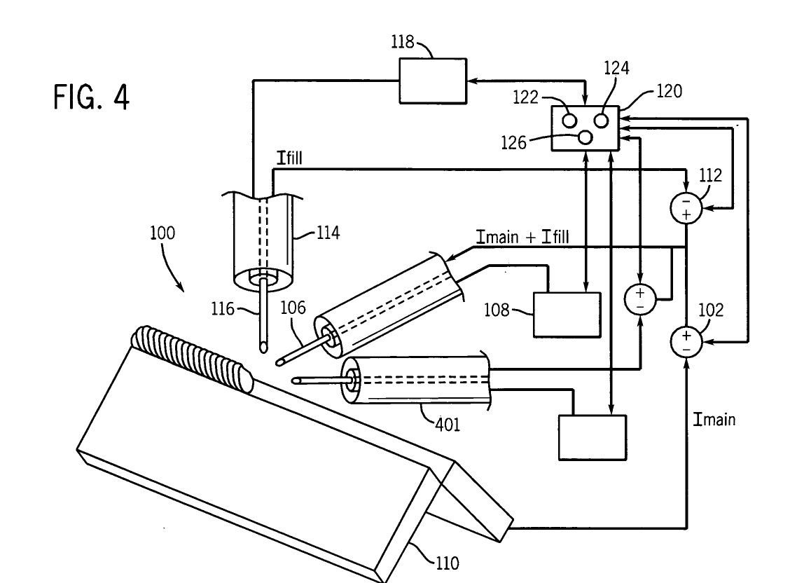

Another alternative provides for having 3 or more MIG guns. For example, FIG. 4 shows another EN gun. It may share the EN power supply, or have its own power supply. The EN guns are fill guns, and the EP gun is the main gun (since it carries all of the current). Different numbers of guns and different combinations of EN and EP guns are used in various embodiments.

Another alternative includes using two guns, both of the same polarity. This would be tandem MIG welding (since neither wire is a common current path), but could advantageously use the mounting and control systems described herein.

Numerous modifications may be made to the present invention which still fall within the intended scope hereof. Thus, it should be apparent that there has been provided in accordance with the present invention a method and apparatus for MIG-MIG welding that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A MIG-MIG welding system comprising:
a first source of wire, disposed to provide a first wire to a main arc between the first wire and a workpiece;
a first source of EP MIG power; disposed to provide a first current having a path including the first wire and the workpiece;
a second source of wire, disposed to provide a second wire to a filler arc between the first wire and the second wire; and
a second source of EN MIG power, disposed to provide a second current having a path including the first wire and the second wire.

2. The system of claim one, further comprising a user adjustable voltage control that effects a change in the intersection of the first wire and the second wire.

3. The system of claim one, wherein the user adjustable voltage control is an arc voltage control.

4. The system of claim one, wherein the main arc and the filler arc spatially overlap.

5. The system of claim one, further comprising a first MIG gun through which the first wire is provided in a first direction, a second MIG gun through which the second wire is provided in a second direction at an angle A relative to the first direction, wherein the first MIG gun and the second MIG gun are mounted on a gun assembly, and further wherein the gun assembly includes an adjustment mechanism for adjusting angle A.

6. The system of claim 5, wherein the adjustment mechanism is responsive to at least one of a user adjustable control, a main arc feedback signal, a filler arc feedback signal, and an output feedback signal.

7. The system of claim one, wherein the first wire is a solid wire.

8. The system of claim 7, wherein the second wire is a solid wire.

9. The system of claim 7, wherein the second wire is a tubular wire.

10. The system of claim one, wherein the first wire is a tubular wire.

11. The system of claim one, wherein the first wire has a first alloy composition, and the second wire has a second alloy composition, and wherein the first alloy composition is different from the second alloy composition.

12. The system of claim one, wherein the first wire has a first wire size, and the second wire has a second wire size, and wherein the first wire size is different from the second wire size.

13. The system of claim one, wherein the first source of EP MIG power is a first source of CV, EP MIG power and the second source of EN MIG power is a first source of CV, EN MIG power.

14. The system of claim one, wherein the first source of EP MIG power is a first source of CV, EP MIG power and the second source of EN MIG power is a second source of CC, EN MIG power.

15. The system of claim one, wherein the first source of EP MIG power is a first source of CC, EP MIG power and the second source of EN MIG power is a second source of CV, EN MIG power.

16. The system of claim one, wherein the first source of EP MIG power is a first source of CC, EP MIG power and the second source of EN MIG power is a second source of CC, EN MIG power.

17. The system of claim one, wherein the first source of EP MIG power is a first source of pulse MIG power.

18. The system of claim one, wherein the first source of EP MIG power is a first source of spray MIG power.

19. The system of claim one, further comprising a controller, wherein the controller includes a first wire feed speed output connected to the first source of wire, and a second wire speed output connected to the second source of wire, wherein the controller provides a first signal on the first wire feed speed output indicative of a first wire feed speed, and provides second signal on the second wire speed output indicative of a second wire feed speed, and further wherein the controller has a user adjustable balance control that effects a change in a ratio of the first wire feed speed to the second wire feed speed, without changing the sum of the first wire feed speed and the second wire feed speed.

20. The system of claim 19 wherein the controller further comprises a user adjustable wire feed speed control that effects a change in the sum of the first wire feed speed and the second wire feed speed, without changing the ratio.

21. The system of claim 19, wherein the user adjustable balance control is a penetration control.

22. The system of claim one, further comprising a controller, wherein the controller includes a first wire feed speed output connected to the first source of wire, and a second wire speed output connected to the second source of wire, wherein the controller provides a first signal on the first wire feed speed output indicative of a first wire feed speed, and provides second signal on the second wire speed output indicative of a second wire feed speed, and further wherein the controller receives at least one of a main arc feedback signal, a filler arc feedback signal, and an output feedback signal, and in response thereto effects a change in a ratio of the first wire feed speed to the second wire feed speed, without changing the sum of the first wire feed speed and the second wire feed speed.

23. The system of claim one, further comprising a controller, wherein the controller includes a first wire feed speed output connected to the first source of wire, and a second wire speed output connected to the second source of wire, wherein the controller provides a first signal on the first wire feed speed output indicative of a first wire feed speed, and provides second signal on the second wire speed output indicative of a second wire feed speed, and further wherein the controller has a user adjustable first wire feed speed control that effects a change in the first wire feed speed output without effecting a change in the second wire feed speed output, and further wherein the controller has a user adjustable second wire feed speed control that effects a change in the second wire feed speed output without effecting a change in the first wire feed speed output.

24. The system of claim one, wherein the first source of EP MIG power controls the first current to have a desired first magnitude and the second source of EN MIG power controls the second current to have a desired second magnitude, and further comprising a user adjustable balance control that effects a change in the ratio of the first magnitude to the second magnitude, without changing the sum of the first magnitude and the second magnitude.

25. The system of claim one, wherein the first source of EP MIG power controls the first current to have a desired first magnitude and the second source of EN MIG power controls the second current to have a desired second magnitude, and further comprising at least one of a main arc feedback, an output feedback, and a filler arc feedback, and in response thereto a change in the ratio of the first magnitude to the second magnitude is effected, without changing the sum of the first magnitude and the second magnitude.

26. The system of claim 25 further comprising a user adjustable current control that effects a change in the sum of the first magnitude and the second magnitude, without changing the ratio.

27. The system of claim 26, wherein the user adjustable balance control is a penetration control.

28. The system of claim one, wherein the first source of EP MIG power controls the first current to have a desired first magnitude and the second source of EN MIG power controls the second current to have a desired second magnitude, and further comprising a user adjustable first current control that effects a change in the first magnitude without changing the second magnitude, and a user adjustable second current control that effects a change in the second magnitude without changing the first magnitude.

29. A method of MIG-MIG welding comprising:
feeding a first wire to a main arc between the first wire and a workpiece;
providing EP MIG power through a first current path including the first wire and the workpiece;
feeding a second wire to a filler arc between the first wire and the second wire; and
providing EN MIG power through a second current path including the first wire and the second wire.

30. The method of claim 29, further comprising controlling the intersection of the first wire and the second wire in response to a user adjustable voltage control.

31. The method of claim 30 wherein feeding a first wire includes feeding the first wire through a first MIG gun in a first direction and feeding a second wire includes feeding the second wire through a second MIG gun in a second direction at an angle A relative to the first direction, and further comprising adjusting the angle A to control the process.

32. The method of claim 28, wherein the adjusting is in response to a user adjustable control.

33. The method of claim 30 wherein feeding a first wire includes feeding a solid wire.

34. The method of claim 30 wherein feeding a second wire includes feeding a solid wire.

35. The method of claim 30 wherein feeding a second wire includes feeding a tubular wire.

36. The method of claim 30 wherein feeding a first wire includes feeding a wire with a first alloy composition, and feeding a second wire includes feeding a wire with a second alloy composition, wherein the first alloy composition is different from the second alloy composition.

37. The method of claim 30, wherein feeding a first wire includes feeding a wire with a first wire size and feeding a second wire includes feeding a wire with a second wire size, wherein the first wire size is different from the second wire size.

38. The method of claim 30, wherein providing EP MIG power includes providing CV, EP MIG power and providing EN MIG power includes providing CV, EN MIG power.

39. The method of claim 30, wherein providing EP MIG power includes providing CV, EP MIG power and providing EN MIG power includes providing CC, EN MIG power.

40. The method of claim 30, wherein providing EP MIG power includes providing CC, EP MIG power.

41. The method of claim 40, wherein providing EN MIG power includes providing CV, EN MIG power.

42. The method of claim 41, wherein providing EN MIG power includes providing CC, EN MIG power.

43. The method of claim 29, further comprising:
controlling the wire feed speed of the first wire to be a first speed;
controlling the wire feed speed of the second wire to be a second speed; and
changing the ratio of the first speed to the second speed without changing the sum of the first speed and the second speed.

44. The method of claim 43 wherein changing is done in response to a user adjustable balance control.

45. The method of claim 29, further comprising:
controlling the wire feed speed of the first wire to be a first speed;
controlling the wire feed speed of the second wire to be a second speed; and
changing the sum of the first speed and the second speed without changing the ratio of the first speed to the second speed.

46. The method of claim 45 wherein changing is done in response to a user adjustable wire feed speed control.

47. The method of claim 29, further comprising:
controlling the EP MIG power to have a first current with a desired first magnitude;
controlling the EN MIG power to have a second current with a desired second magnitude; and
changing the ratio of the first magnitude to the second magnitude, without changing the sum of the first magnitude and the second magnitude.

48. The method of claim 47 wherein changing is done in response to a user adjustable balance control.

49. The method of claim 29, further comprising:
controlling the EP MIG power to have a first current with a desired first magnitude;
controlling the EN MIG power to have a second current with a desired second magnitude; and
changing the sum of the first magnitude and the second magnitude, without changing the ratio of the first magnitude to the second magnitude.

50. The method of claim 49 wherein changing is done in response to a user adjustable current control.

51. The method of claim 29 wherein the EP MIG power is pulse MIG power.

52. The method of claim 29 wherein the EP MIG power is spray MIG power.

53. The method of claim 29 wherein the EN MIG power is pulse MIG power.

54. The method of claim 29 wherein the EN MIG power is spray MIG power.

55. A method of filling a gap using MIG-MIG welding comprising:
feeding a first wire to a main arc between the first wire and a workpiece;
providing MIG power through a first current path including the first wire and the workpiece;
feeding a second wire to a filler arc between the first wire and the second wire;
providing MIG power through a second current path including the first wire and the second wire; and
therein melting the first wire and the second wire to fill the gap.

56. A method of hard-facing comprising:
feeding a first wire to a main arc between the first wire and a workpiece;
providing MIG power at a first magnitude through a first current path including the first wire and the workpiece;
feeding a second wire to a filler arc between the first wire and the second wire; and
providing MIG power at a second magnitude through a second current path including the first wire and the second wire, wherein the second magnitude is greater than the first magnitude;
wherein at least one of the first and second wires includes carborundum.

57. A MIG-MIG-MIG welding system comprising:
a first source of wire, disposed to provide a first wire to a main arc between the first wire and a workpiece;
a first source of EP MIG power; disposed to provide a first current having a path including the first wire and the workpiece;
a second source of wire, disposed to provide a second wire to a filler arc between the first wire and the second wire;
a second source of EN MIG power, disposed to provide a second current having a path including the first wire and the second wire;
a third source of wire, disposed to provide a third wire to a third arc between the first wire and the third wire; and
a third source of EN MIG power, disposed to provide a third current having a path including the first wire and the third wire.
